(19) United States
(12) Patent Application Publication
(10) Pub. No.: US 2026/0233745 A1
(43) Pub. Date: Aug. 13, 2026

(54) CONTROL APPARATUS FOR VEHICLE

(71) Applicant: SUBARU CORPORATION, Tokyo (JP)

(72) Inventor: Shinji SAWADA, Tokyo (JP)

(21) Appl. No.: 19/563,153

(22) Filed: Mar. 11, 2026

Related U.S. Application Data
(63) Continuation of application No. PCT/JP2023/036006, filed on Oct. 3, 2023.

(51) Int. Cl. B60W 40/068

(52) U.S. Cl. CPC B60W 40/068; B60W 2520/26; B60W 2552/40

(57) ABSTRACT

A controller included in a control apparatus for a vehicle of the invention includes a slip vibration detector, an estimated road surface friction coefficient calculator, a comparator, and an output unit. The slip vibration detector is configured to detect a slip vibration of a drive wheel. The estimated road surface friction coefficient calculator is configured to determine an estimated road surface friction coefficient, based on the slip vibration. The comparator is configured to compare the estimated road surface friction coefficient with a slip reporting threshold. The output unit is configured to output a reporting command signal to the reporter when the comparator determines that the estimated road surface friction coefficient is less than or equal to the slip reporting threshold. The controller further includes a slip reporting threshold setter configured to variably set the slip reporting threshold in accordance with a road shape recognized based on the travel environment information.

### CROSS-REFERENCE TO RELATED APPLICATIONS

This application is continuation of International Application No. PCT/JP2023/036006, filed on Oct. 3, 2023, the entire contents of which are hereby incorporated by reference.

### TECHNICAL FIELD

The invention relates to a control apparatus for a vehicle.

### BACKGROUND ART

A traveling vehicle slips when drive power exerted on tires of drive wheels (referred to as “drive tires”) exceeds grip force from a road surface acting on the drive tires (referred to as “road surface grip force”). As illustrated in FIG. 7, drive power P of a drive tire (a front wheel in the drawing) of a vehicle M is determined by the following equation:

$$P = T / r \qquad ( 1 )$$

where T is torque of the drive tire and r is an effective radius of the drive tire.

Further, the road surface grip force F is determined by the following equation:

$$F = μ \cdot Wf \qquad ( 2 )$$

where μ is a road surface friction coefficient, Wf is a vehicle body weight on the drive tire (front wheel). In FIG. 7, W is a total vehicle body weight, and Wr is a body weight on a driven tire (rear wheel).

On snowy or icy roads with a low road surface μ, F<P is satisfied, which causes the drive wheels to be easier to slip.

For example, Japanese Unexamined Patent Application Publication No. 2013-112192 discloses a technique of causing, when a vehicle slip is detected based on the difference between the rotation speed of the drive wheels and that of the driven wheels, a reaction force control apparatus to apply a reaction force to an accelerator pedal, to thereby inform a driver that a slip has occurred.

When traveling on a low-μ road such as a snow-covered road, the driver often knows in advance slip occurrence situations. However, in the technique disclosed in Japanese Unexamined Patent Application Publication No. 2013-112192 described above, the slip occurrence situations are uniformly detected, and the reaction force control apparatus applies the reaction force to the accelerator pedal.

Consequently, the driver feels that the reaction force to the accelerator pedal comes earlier than he or she expects, in some cases. The driver also feels that the reaction force to the accelerator pedal is unnecessary, in some cases.

An object of the invention, which has been made in view of the aforementioned circumstances, is to provide a control apparatus for a vehicle that makes it possible to vary the timing of reporting the possibility of slip occurrence in accordance with sensitivity of the driver.

### SUMMARY OF INVENTION

### Means for Solving the Problem

An aspect of the invention includes a travel environment information acquirer, a reporter, and a controller. The travel environment information acquirer is configured to acquire travel environment information regarding a travel environment in front of the vehicle. The reporter is configured to report a possibility of slip occurrence. The controller includes a slip vibration detector, an estimated road surface friction coefficient calculator, a comparator, and an output unit. The slip vibration detector is configured to detect a slip vibration of a drive wheel. The estimated road surface friction coefficient calculator is configured to calculate an estimated road surface friction coefficient, based on the slip vibration detected by the slip vibration detector. The comparator is configured to compare the estimated road surface friction coefficient calculated by the estimated road surface friction coefficient calculator with a slip reporting threshold. The output unit is configured to output a reporting command signal to the reporter when the comparator determines that the estimated road surface friction coefficient is less than or equal to the slip reporting threshold. The controller further includes a slip reporting threshold setter. The slip reporting threshold setter is configured to variably set the slip reporting threshold in accordance with a road shape recognized based on the travel environment information acquired by the travel environment information acquirer.

An aspect of the invention includes a travel environment information acquirer, a reporter, and a controller. The travel environment information acquirer is configured to acquire travel environment information regarding a travel environment in front of the vehicle. The reporter is configured to report a possibility of slip occurrence. The controller includes a slip vibration detector, an estimated road surface friction coefficient calculator, a corrected road surface friction coefficient calculator, a comparator, and an output unit. The slip vibration detector is configured to detect a slip vibration of a drive wheel. The estimated road surface friction coefficient calculator is configured to calculate an estimated road surface friction coefficient, based on the slip vibration detected by the slip vibration detector. The corrected road surface friction coefficient calculator is configured to calculate a corrected road surface friction coefficient by correcting the estimated road surface friction coefficient calculated by the estimated road surface friction coefficient calculator with a correction coefficient set in accordance with a road shape recognized based on the travel environment information acquired by the travel environment information acquirer. The comparator is configured to compare the corrected road surface friction coefficient set by the corrected road surface friction coefficient calculator with a slip reporting threshold. The output unit is configured to output a reporting command signal to the reporter when the comparator determines that the estimated road surface friction coefficient is less than or equal to the slip reporting threshold.

### BRIEF DESCRIPTION OF DRAWINGS

FIG. 1 is a schematic configuration diagram of a control apparatus installed in an electric vehicle.

FIG. 2A is a flowchart illustrating a slip reporting control routine (Part 1).

FIG. 2B is a flowchart illustrating the slip reporting control routine (Part 2)

FIG. 3 is a diagram illustrating traveling control performed on a curved road with no oncoming vehicles.

FIG. 4 is an explanatory diagram illustrating traveling control performed on a curved road with an oncoming vehicle approaching.

FIG. 5 is an explanatory diagram illustrating traveling control performed on a curved road with a narrow road width.

FIG. 6 is a flowchart illustrating a slip reporting control routine according to another embodiment.

FIG. 7 is an explanatory diagram illustrating the relationship between drive power of drive tires and a road surface grip force.

### MODES FOR CARRYING OUT THE INVENTION

Some embodiments of the invention will be described below with reference to the accompanying drawings. It should be noted that the drawings are schematic, and the relationship among the thicknesses and widths of the components and the ratio among the thicknesses of the components may differ from the reality, and it is needless to say that there are parts where the relationship and ratio of dimension differs even among the drawings.

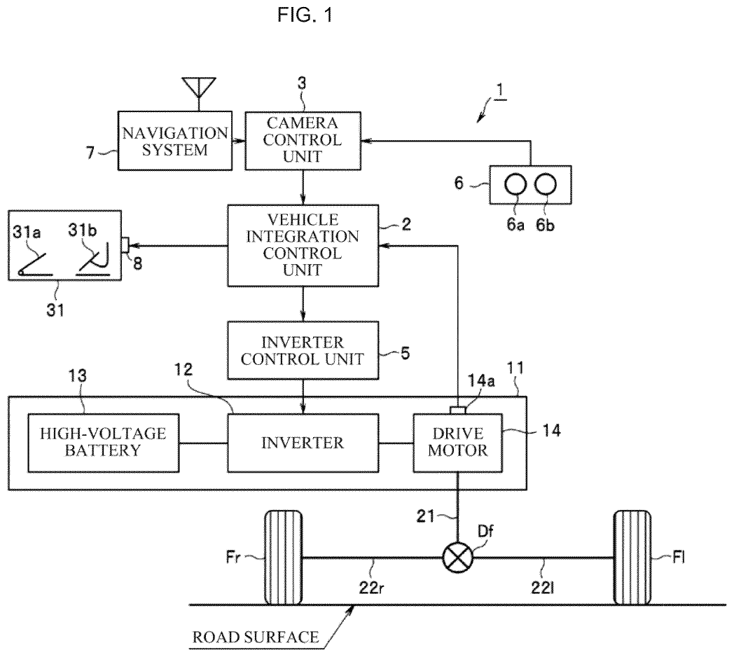

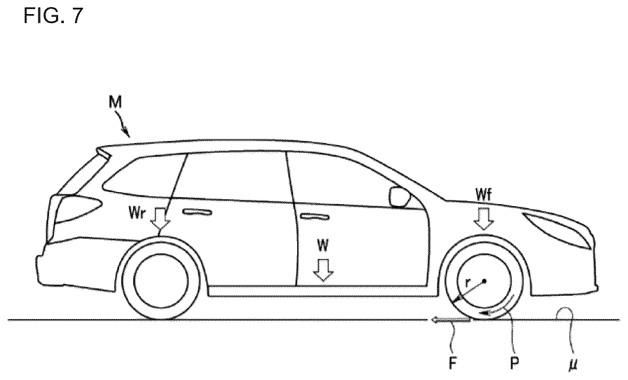

A reference numeral 1 in FIG. 1 represents a drive control apparatus. The drive control apparatus 1 is mounted on a vehicle M (see FIG. 7). The vehicle M is an electric vehicle. The vehicle M will hereinafter be referred to as an “electric vehicle M”.

The drive control apparatus 1 has a vehicle integration control unit 2 serving as a controller. The vehicle integration control unit 2 comprehensively performs various types of control related to driving of the electric vehicle M. A camera control unit 3 is coupled to an input side of the vehicle integration control unit 2. Note that, although not illustrated in the drawings, various sensors are coupled to the vehicle integration control unit 2 to acquire information necessary for driving the electric vehicle M.

Further, a vibration sensor 14a is coupled to the input side of the vehicle integration control unit 2. The vibration sensor 14a detects a vibration (hereinafter referred to as a “motor vibration”) (Hz) generated in a rotational speed of the drive motor 14, which is described below.

An inverter control unit 5 and a pressure actuator 8 as a reporter are coupled to an output side of the vehicle integration control unit 2. Note that, although not illustrated in the drawings, the vehicle integration control unit 2 is coupled to various controllers for bidirectional communication.

Each of the control units 2, 3, and 5 includes a microcontroller including a CPU, a RAM, a ROM, a rewritable nonvolatile memory (flash memory or EEPROM), and peripheral devices. The ROM stores programs, fixed data, and other data to be used for the CPU to execute each process. The RAM is provided as a work area for the CPU and temporarily stores various kinds of data related to the CPU. Note that the CPU is also called a microprocessor (MPU) or a processor. A graphics processing unit (GPU) or a graph streaming processor (GSP) may also be used in place of the CPU. Alternatively, a selective combination of the CPU, the GPU, and the GSP may be used.

An inverter 12 of an electric powertrain 11 is coupled to the inverter control unit 5. The electric powertrain 11 includes the inverter 12, a high-voltage battery 13, and a drive motor 14. The inverter 12 is operated by a command signal from the inverter control unit 5. The inverter 12 converts a direct current (DC) of the high-voltage battery 13 to an alternating current (AC) to feed electric power to the drive motor 14 in accordance with the command signal from the inverter control unit 5. The inverter control unit 5 controls drive power of the drive motor 14 by vector control.

The drive motor 14 has an output shaft 21 coupled to a drive shaft 22l of a left drive wheels Fl and a drive shaft 22r of a right drive wheel Fr through a differential Df. The drive motor 14 drives the drive wheels Fl and Fr with the electric power supplied from the inverter 12 to power the electric vehicle M.

A reference numeral 31 represents a pedal operation unit. The pedal operation unit 31 is operated by a driver and includes an accelerator pedal 31a and a brake pedal 31b. The accelerator pedal 31a is used to set a vehicle speed. The pressure actuator 8 is coupled to the accelerator pedal 31a and the brake pedal 31b. The pressure actuator 8 applies a reaction force to the accelerator pedal 31a and the brake pedal 31b in accordance with a command from the vehicle integration control unit 2.

A camera unit 6 is installed at a front part of the electric vehicle M. The camera unit 6 includes a stereo camera including a main camera 6a and a sub-camera 6b. The camera control unit 3 processes images of a travel environment in front of the electric vehicle M captured by both the cameras 6a and 6b, thereby acquiring forward travel environment information. Accordingly, the camera control unit 3 has a function of a travel environment information acquirer of the invention.

The forward travel environment information to be acquired includes data on a road shape (e.g., straight road or curved road) in front of the electric vehicle M, preceding vehicles, and oncoming vehicles traveling in the opposite lane.

In addition, a navigation system 7 is coupled to the camera control unit 3. The navigation system 7 includes a memory that stores road map information. The navigation system 7 acquires own-vehicle location information (latitude, longitude, and altitude), based on the global navigation satellite system (GNSS). The own-vehicle location information is information regarding a current position of the electric vehicle M.

The navigation system 7 then plots the acquired own-vehicle location on the road map information stored in the memory to estimate the current own-vehicle location and a current travel direction on the road map.

In addition, the navigation system 7 acquires environment information on an environment around the current own-vehicle location, based on the road map information. The environment information is then output to the vehicle integration control unit 2 through the camera control unit 3. Accordingly, the navigation system 7 also has a function of the travel environment information acquirer of the invention.

The environment information to be acquired by the navigation system 7 includes data on a road shape such as straight road or a curved road.

Upon detection of the possibility of slip occurrence on the drive wheels Fl and Fr, the vehicle integration control unit 2 operates the pressure actuator 8 to apply a reaction force to the accelerator pedal 31a and the brake pedal 31b. This reports the slip occurrence to the driver.

However, for example, when traveling on a low-μ curved road, the driver believes that it is possible to continue traveling by swinging the vehicle a little wide, rather than passing in the center of the lane, to reduce the lateral slip and for more stable traveling. In this embodiment, a threshold for reporting the possibility of slip occurrence varies depending on the road shape and the presence or absence of oncoming vehicles.

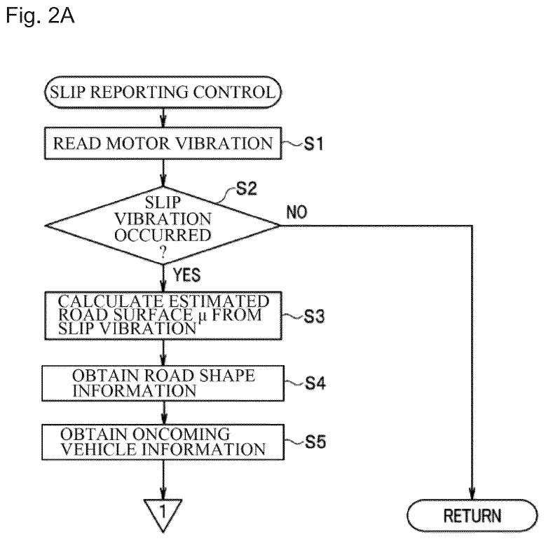

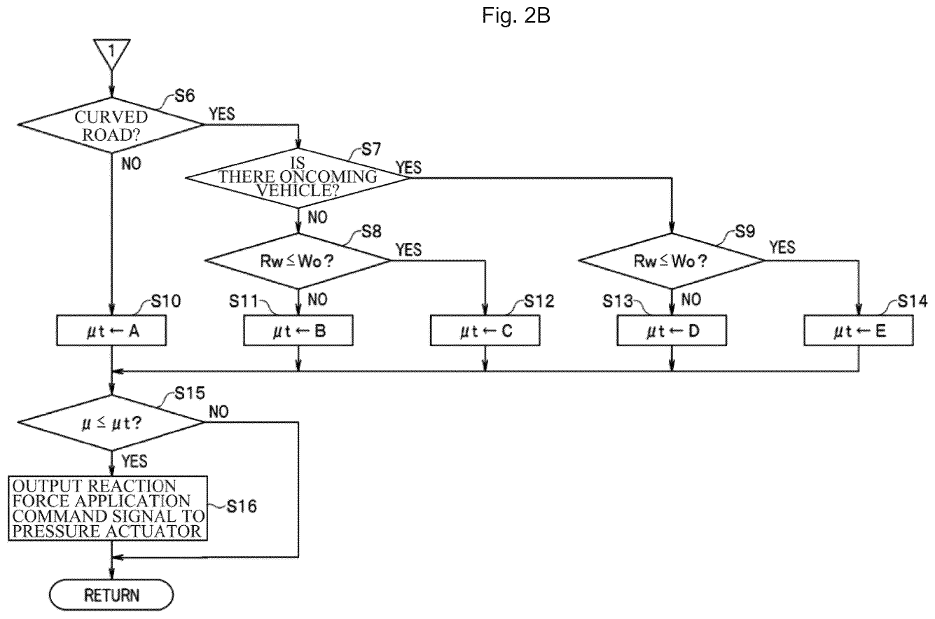

Specifically, the slip reporting control is performed by the vehicle integration control unit 2 in accordance with a slip reporting control routine illustrated in FIGS. 2A and 2B.

The vehicle integration control unit 2 reads the motor vibration (Hz) detected by the vibration sensor 14a (Step S1). The vibration sensor 14a detects the vibration (Hz) generated in the rotational speed of the drive motor 14. Subsequently, based on the motor vibration (Hz) detected by the vibration sensor 14a, the vehicle integration control unit 2 checks whether a slip vibration is occurring in the drive motor 14 (Step S2). Note that the processing in Steps S1 and S2 corresponds to a slip vibration detector of the invention.

When a sudden torque fluctuation occurs in the drive motor 14, a vibration occurs in the rotational speed of the drive motor 14. When the drive wheels Fl and Fr idle (slip), a high frequency motor vibration is generated in the rotational speed of the drive motor 14.

When the motor vibration is greater than or equal to a set frequency, the vehicle integration control unit 2 determines that the slip vibration has occurred (Step S2: YES). When the motor vibration is less than the set frequency, the vehicle integration control unit 2 determines that no slip vibration has occurred (Step S2: NO). When it is determined that no slip vibration has occurred (Step S22: NO), the procedure exits the routine.

When determining that the slip vibration has occurred (Step S22: YES), the vehicle integration control unit 2 calculates an estimated road surface friction coefficient (estimated road surface μ), based on the slip vibration (Step S3). The processing in Step S3 corresponds to an estimated road surface friction coefficient calculator of the invention.

Thereafter, the vehicle integration control unit 2 acquires information regarding a road surface shape (e.g., a straight road, a road, and a road width) in front of the electric vehicle M (Step S4). The road surface shape is acquired from the road map information, based on the own-vehicle location acquired by the navigation system 7. Alternatively, the road shape information is acquired from the forward travel environment information related to the electric vehicle M recognized by the camera control unit 3.

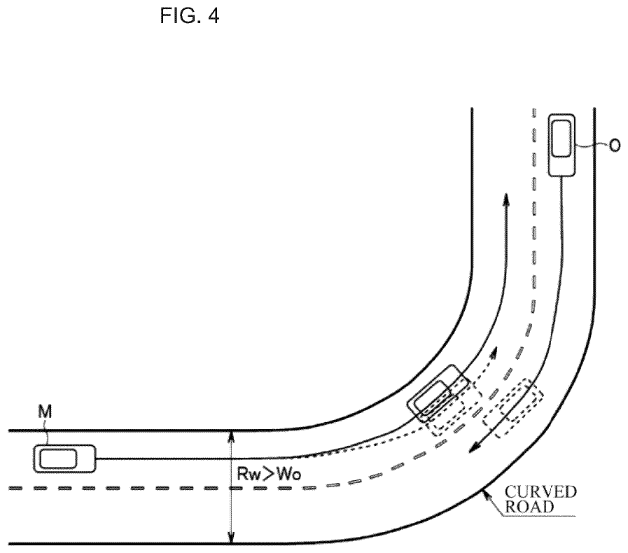

The vehicle integration control unit 2 also acquires oncoming vehicle information as to whether an oncoming vehicle O (see FIG. 4) is approaching on the oncoming lane (Step S5). The oncoming vehicle information is acquired from the forward travel environment information related to the electric vehicle M recognized by the camera control unit 3. Alternatively, the oncoming vehicle information is acquired through inter-vehicle communication made with the oncoming vehicle O.

Thereafter, the vehicle integration control unit 2 checks whether the road ahead is a curved road, based on the road shape information acquired in Step S4 (Step S6). If the road is a curved road, the procedure proceeds to Step S7. If the road is a straight road, the procedure proceeds to Step S10.

The vehicle integration control unit 2 checks whether the oncoming vehicle O is approaching, based on of the oncoming vehicle information acquired in Step S5 (Step S7). Thereafter, when it is determined that no oncoming vehicle O has been detected, the procedure proceeds to Step S8. In contrast, when it is determined that the approach of the oncoming vehicle O has been detected, the procedure proceeds to Step S9. In Step S8, the vehicle integration control unit 2 compares a road width Rw with a predetermined narrow road determination threshold Wo, based on the road shape information acquired by the navigation system 7 or the camera control unit 3. Thereafter, when the vehicle integration control unit 2 determines that Rw>Wo, the procedure proceeds to Step S11. In contrast, when the vehicle integration control unit 2 determines that Rw≤Wo, the procedure proceeds to Step S12.

Meanwhile, the vehicle integration control unit 2 compares the road width Rw with the predetermined narrow road determination threshold Wo (Step S9). Thereafter, when the vehicle integration control unit 2 determines that Rw>Wo, the procedure proceeds to Step S13. In contrast, when the vehicle integration control unit 2 determines that Rw≤Wo, the procedure proceeds to Step S14.

The vehicle integration control unit 2 sets a slip reporting threshold μt at a first initial value A (e.g., μ=0.1) (Step S10), and the procedure proceeds to Step S15. The slip reporting threshold μt is set in Step S10 on the assumption of traveling on a straight road.

Further, the vehicle integration control unit 2 sets the slip reporting threshold μt at a second initial value B (e.g., μ=0.3) (Step S11), and the procedure proceeds to Step S15. The slip reporting threshold μt is set in Step S11 on the assumption of traveling on a curved road.

Further, the vehicle integration control unit 2 sets the slip reporting threshold μt at a third initial value C (e.g., μ=0.5) (Step S12), and the procedure proceeds to Step S15. The slip reporting threshold μt is set in Step S12 on the assumption of a curved road with a narrow width.

Further, the vehicle integration control unit 2 sets the slip reporting threshold μt at a fourth initial value D (e.g., μ=0.7) (Step S13), and the procedure proceeds to Step S15. The slip reporting threshold μt is set in Step S13 on the assumption of a curved road with the oncoming vehicle O approaching.

Further, the vehicle integration control unit 2 sets the slip reporting threshold μt at a fifth initial value E (e.g., μ=0.9) (Step S14), and the procedure proceeds to Step S15. The slip reporting threshold μt is set in Step S14 on the assumption of a curved road with a narrow width and the oncoming vehicle O approaching. Note that the processing in Steps S10 to S14 corresponds to a slip reporting threshold setter of the invention.

Each of the above initial values A to E is set in accordance with the sensitivity of the driver during driving of the electric vehicle M (A<B<C<D<E). In other words, the slip reporting threshold μt is set at the first initial value A of the lowest road surface μ mduring driving on a straight road. For example, when the road surface μ of the first initial value A is 0.1, it is determined to be NO in Step S15 described below on a traveling road with μ<0.1. Hence, the vehicle integration control unit 2 refrains from outputting a reaction force application command signal. This reduces the frequency of unnecessary application of reaction force and reduce the discomfort to be felt by the driver.

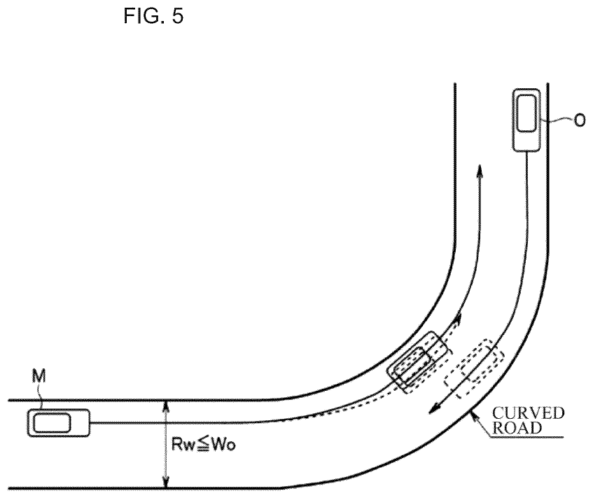

In contrast, in a case of a curved road with the oncoming vehicle O approaching and having a narrow road width Rw (Rw≤Wo) as illustrated in FIG. 5, settings are made in Step S14 with the fifth initial value E having the highest road surface μ. For example, when the road surface μ of the fifth initial value E is 0.9, it is determined to be YES in Step S15 described below on a traveling road with μ≥0.9.

This increases the frequency of output of the reaction force application command signal from the vehicle integration control unit 2, thereby allowing the vehicle integration control unit 2 to report the possibility of slip occurrence at an early stage to the driver. This prevents the electric vehicle M from swinging wide to the opposite lane when passing the oncoming vehicle O, as indicated by a dashed line in FIG. 5.

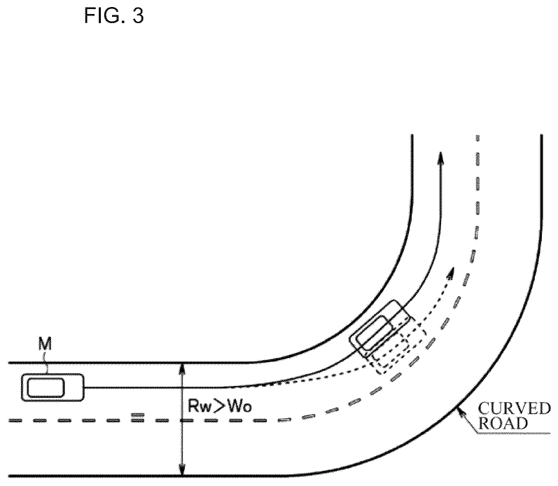

In addition, even on a curved road as illustrated in FIG. 3, when the road width Rw is relatively wide (Rw>Wo) and no oncoming vehicle O is approaching, the slip reporting threshold μt is set at the second initial value B greater than the first initial value A (Step S11). Accordingly, even if the electric vehicle M swings a little wide from the target travel path indicated by a solid line, as indicated by a dashed line in FIG. 3, the vehicle integration control unit 2 refrains from outputting the reaction force application command signal. This allows the vehicle integration control unit 2 to report the possibility of slip occurrence at a timing substantially in line with the driver's sensitivity.

In contrast, in a case of a curved road with no oncoming vehicle O approaching and having a relatively narrow road width (Rw≤Wo), the slip reporting threshold μt is set in Step S12 at the third initial value C greater than the second initial value B. Accordingly, assuming the case illustrated in FIG. 5 with no oncoming vehicle O approaching, the vehicle integration control unit 2 refrains from outputting the reaction force application command signal until the vehicle swings wide to the opposite lane, going out of the dashed line illustrated in FIG. 5. Hence, even in this case, the vehicle integration control unit 2 is allowed to report the possibility of slip occurrence at a timing substantially in line with the driver's sensibilities.

Furthermore, even in a case of a curved road with the oncoming vehicle O approaching and having a relatively wide road width Rw (Rw>Wo) as illustrated in FIG. 4, the slip reporting threshold μt is set in Step S13 at the fourth initial value D greater than the third initial value C. Accordingly, as indicated by the dashed line in FIG. 4, when there is a possibility that the electric vehicle M may swing wide to the oncoming lane, the vehicle integration control unit 2 outputs the reaction force application command signal at an early stage. This makes it possible to enhance safety when the driver drives the electric vehicle M along the curve road.

Thereafter, the vehicle integration control unit 2 compares the estimated road surface μ with the slip reporting threshold μt (Step S15). The processing in Step S15 corresponds to a comparator of the invention.

In a case where μ≤μt (YES), the vehicle integration control unit 2 determines that there is the possibility of slip occurrence, and the procedure proceeds to Step S16. In a case where μ>μt (NO), the procedure exits the routine.

In Step S16, the vehicle integration control unit 2 outputs the reaction force application command signal to generate a reaction force to the pressure actuator 8, and the procedure exits the routine.

The pressure actuator 8 outputs a pressure indication value to the accelerator pedal 31a and the brake pedal 31b in accordance with the pressure application command signal from the vehicle integration control unit 2. The pressure indication value indicates the force that opposes the pressure generated when the driver presses either the accelerator pedal 31a or the brake pedal.

The reaction force indication value may simply apply a repulsive force to the accelerator pedal 31a and the brake pedal 31b. The reaction force indication value may also generate vibration against the accelerator pedal 31a and the brake pedal 31b. Further, the reaction force indication value may apply a repulsive force and a vibration to the accelerator pedal 31a and the brake pedal 31b simultaneously or alternately.

The driver recognizes the possibility of slip occurrence on the drive wheels Fl and Fr by experiencing the reaction force received when pressing either the accelerator pedal 31a or the brake pedal 31b.

As described above, in this embodiment, the slip reporting threshold μt is set variably in accordance with the road shape and the presence or absence of the oncoming vehicle O. This allows the timing for reporting the possibility of slip occurrence to be set in accordance with the driver's sensitivity. This reduces the frequency of unnecessary application of reaction force to the accelerator pedal 31a and the brake pedal 31b, and the discomfort to be felt by the driver.

In addition, in a case of a curved road with the oncoming vehicle O approaching and having a narrow road width Rw (Rw≤Wo), the slip reporting threshold μt is set at a relatively high road surface μ. This allows the vehicle integration control unit 2 to report the possibility of slip occurrence to the driver at an early stage. This enhances safety during traveling on a curved road.

### Other Embodiments

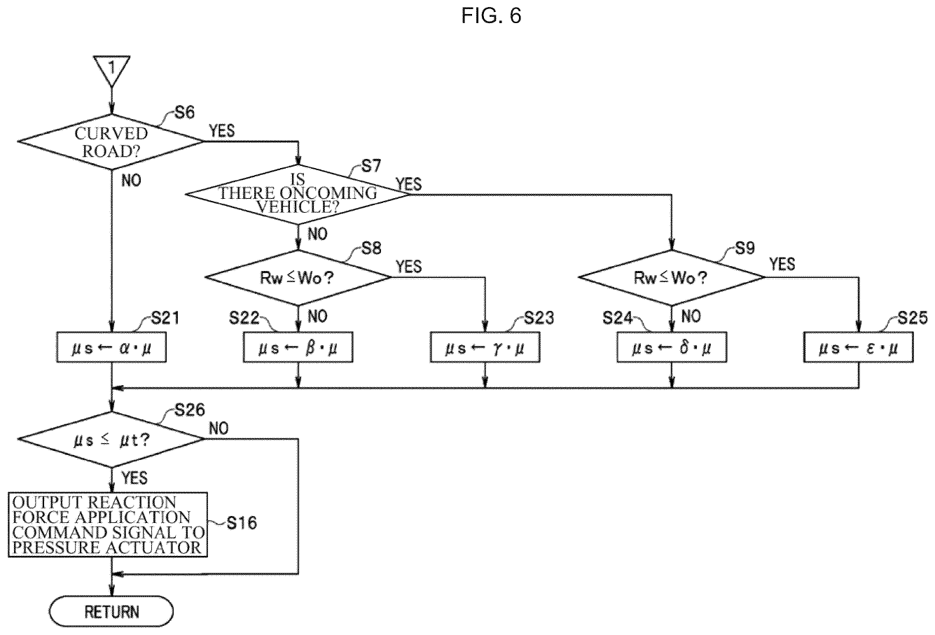

FIG. 6 illustrates another embodiment of the slip suppression control routine illustrated in FIG. 2B. In the routine illustrated in FIG. 2B, the slip reporting threshold μt is set in accordance with the road shape and the presence or absence of the oncoming vehicle O. In contrast, in the slip suppression control routine illustrated in FIG. 6, the slip reporting threshold μt is set at a constant value, and a corrected road surface μs to be compared is set by multiplying the estimated road surface μ by a gain set in accordance with the road shape and the presence or absence of the oncoming vehicle O.

Since Steps S1 to S9 are the same as those in the flowchart illustrated in FIGS. 2A and 2B, a description of these steps will be omitted.

If determining in Step S6 that the road is a straight road (NO), the vehicle integration control unit 2 corrects the estimated road surface μ by a first gain α to thereby set the corrected road surface μs (Step S21: μs←α·μ).

If determining that the road is a curved road (Step S6: YES), and that Rw>Wo (Step S8: NO), the vehicle integration control unit 2 corrects the estimated road surface μ by the second gain β to thereby set the corrected road surface μs (Step S22: μs←β·μ). If determining that Rw≤Wo (Step S8: YES), the vehicle integration control unit 2 corrects the estimated road surface μ by a third gain γ to thereby set the corrected road surface μs (Step S23: μs←γ·μ).

If it is judged that Rw>Wo (Step S9: NO), the vehicle integration control unit 2 corrects the estimated road surface μ by the fourth gain δ to thereby set the corrected road surface μs (Step S24: μs←δ·μ). If it is judged that Rw≤Wo (Step S9: NO), the vehicle integration control unit 2 corrects the estimated road surface μby the fifth gain ε to thereby set the corrected road surface μs (Step S25: μs←ε·μ). The processing in Steps S21 to S26 corresponds to a corrected road surface friction coefficient calculator of the invention.

Thereafter, the vehicle integration control unit 2 compares the corrected road surface μs with the slip reporting threshold μt (Step S26). Note that the processing in Step S26 corresponds to the comparator of the invention.

The slip reporting threshold μt is a fixed value (e.g., μt=0.9) set to reduce unnecessary slip reports, and to report the possibility of slip occurrence at an early stage, as necessary. The first to fifth gains α, β, γ, δ, and ε described above are values set to vary the timing of the slip reporting in accordance with the driver's sensitivity. These gains have the relationship expressed by α>β>γ>δ>ε. For example, α=1.9, β=1.7, γ=1.5, δ=1.3, and ε=1.1 are satisfied.

When determining that μs≤μt (Step S26: YES), the vehicle integration control unit 2 determines that there is the possibility of slip occurrence, and the procedure proceeds to Step S16. When the vehicle integration control unit 2 determines that μs>μt (Step S26: NO), the procedure exits the routine. In Step S16, the vehicle integration control unit 2 outputs, to the pressure actuator 8, the reaction force application command signal to be used to generate a reaction force, and the procedure exits the routine. Note that the processing in Step S16 corresponds to an output unit of the invention.

When the estimated road surface μ is constant, the corrected road surface μs set on a straight road is the value obtained by correcting the estimated road surface μ by the first gain α having the largest value. This increases the frequency of μs>μt, and makes it possible to reduce unnecessary slip reports from the vehicle integration control unit 2. In contrast, when the approach of the oncoming vehicle O is detected on a curved road with a relatively narrow width (Rw≤Wo), the corrected road surface μs is set by correcting the estimated road surface μ by the fifth gain ε having the smallest value. Therefore, when μs≤μt, it is possible to report the possibility of slip occurrence to the driver at an early stage.

As described above, effects similar to those of the embodiment described above are obtainable even the case where the slip reporting threshold μt is set at a constant value, where the estimated road surface μ is multiplied by the gain set in accordance with the road shape and the presence or absence of the oncoming vehicle O, and where the corrected road surface μs to be compared is compared with the slip reporting threshold μt.

Note that the electric vehicle M may be a four-wheel drive vehicle. Although the curved road on which the electric vehicle M travels is illustrated as an inner curve in the drawings, the curved road on which the electric vehicle M travels may be an outer curve.

The means of reporting the possibility of slip occurrence to the driver is not limited to the reaction force applied to the accelerator pedal 31a and the brake pedal 31b; alternatively, the possibility may be reported by displaying on a monitor or audio output through a speaker.

1. A control apparatus for a vehicle, the control apparatus comprising:
a travel environment information acquirer configured to acquire travel environment information regarding a travel environment in front of the vehicle;
a reporter configured to report a possibility of slip occurrence; and
a controller, wherein
the controller comprises
a slip vibration detector configured to detect a slip vibration of a drive wheel of the vehicle,
an estimated road surface friction coefficient calculator configured to calculate an estimated road surface friction coefficient, based on the slip vibration detected by the slip vibration detector,
a comparator configured to compare the estimated road surface friction coefficient calculated by the estimated road surface friction coefficient calculator with a slip reporting threshold, and
an output unit configured to output a reporting command signal to the reporter when the comparator determines that the estimated road surface friction coefficient is less than or equal to the slip reporting threshold, and
the controller further comprises
a slip reporting threshold setter configured to variably set the slip reporting threshold in accordance with a road shape recognized based on the travel environment information acquired by the travel environment information acquirer.

2. The control apparatus for the vehicle according to claim 1, wherein the slip reporting threshold setter is configured to, when the road shape is recognized as a straight road based on the travel environment information acquired by the travel environment information acquirer, set the slip reporting threshold at a lower friction coefficient than when the road shape is recognized as a curved road.

3. The control apparatus for the vehicle according to claim 2, wherein the slip reporting threshold setter is configured to, when the road shape is recognized as a curved road with an oncoming vehicle approaching based on the travel environment information acquired by the travel environment information acquirer, set the slip reporting threshold at a higher friction coefficient than when a curved road is simply recognized.

4. A control apparatus for a vehicle, the control apparatus being comprising:
a travel environment information acquirer configured to acquire travel environment information regarding a travel environment in front of the vehicle;
a reporter configured to report a possibility of slip occurrence; and
a controller, wherein
the controller comprises
a slip vibration detector configured to detect a slip vibration of a drive wheel of the vehicle,
an estimated road surface friction coefficient calculator configured to calculate an estimated road surface friction coefficient, based on the slip vibration detected by the slip vibration detector,
a corrected road surface friction coefficient calculator configured to calculate a corrected road surface friction coefficient by correcting the estimated road surface friction coefficient calculated by the estimated road surface friction coefficient calculator with a correction coefficient set in accordance with a road shape recognized based on the travel environment information acquired by the travel environment information acquirer,
a comparator configured to compare the corrected road surface friction coefficient set by the corrected road surface friction coefficient calculator with a slip reporting threshold, and
an output unit configured to output a reporting command signal to the reporter when the comparator determines that the estimated road surface friction coefficient is less than or equal to the slip reporting threshold.

5. The control apparatus for the vehicle according to claim 4, wherein the corrected road surface friction coefficient calculator is configured to, when the road shape is recognized as a straight road based on the travel environment information acquired by the travel environment information acquirer, correct the estimated road surface friction coefficient with a higher correction coefficient than when the road shape is recognized as a curved road.

6. A control apparatus for a vehicle, the control apparatus comprising:
one or more processors;
one or more memories communicably coupled to the one or more processors, the one or more memories storing instructions configured to cause the one or more processors to carry out processing; and a reporter comprising a pressure actuator, the reporter being configured to report a possibility of slip occurrence of the vehicle, wherein
the processing includes
acquiring travel environment information regarding a travel environment in front of the vehicle,
detecting a slip vibration of a drive wheel of the vehicle,
calculating an estimated road surface friction coefficient, based on the slip vibration,
comparing the estimated road surface friction coefficient with a slip reporting threshold,
outputting a reporting command signal to the reporter when determining that the estimated road surface friction coefficient is less than or equal to the slip reporting threshold, and
variably setting the slip reporting threshold in accordance with a road shape recognized based on the travel environment information.
